(19) United States
(12) Patent Application Publication
(10) Pub. No.: US 2019/0301378 A1
(43) Pub. Date: Oct. 3, 2019

(54) METHOD FOR CONTROLLING AN EMERGENCY UNIT AND VALVE CONTROL DEVICE

(71) Applicant: MTU FRIEDRICHSHAFEN GMBH, Friendrichshafen (DE)

(72) Inventors: Jörg BARRHO, Radolfzell (DE); Dominik DIETENBERGER, Bodnegg (DE)

(21) Appl. No.: 16/317,418

(22) PCT Filed: Jul. 13, 2017
(86) PCT No.: PCT/EP2017/000841

§ 371 Date: Jan. 11, 2019

(30) Foreign Application Priority Data
Aug. 12, 2016 (DE) 102016215125.8

(51) Int. Cl. F02D 31/00; F02D 41/04; F02D 41/22

(52) U.S. Cl. CPC F02D 31/006; F02D 2200/101; F02D 41/222; F02D 41/042

(57) ABSTRACT

A method for controlling an emergency unit of an internal combustion engine including the following steps: inputting a threshold value for an overspeed of the engine; detecting a second rotational speed of the engine with a second rotational speed sensor; checking the plausibility of the second rotational speed. The plausibility checking includes the following steps: inputting a first rotational speed detected by a first rotational speed sensor of an engine control unit; calculating a difference between the second rotational speed and the first rotational speed; comparing the difference with a recorded threshold value for the difference; in the event that the difference is smaller than the threshold value for the difference, emitting a plausibility signal. After receipt of the plausibility signal, the method includes inputting the second rotational speed; and using the second rotational speed for an activation process of the emergency unit according to the overspeed.

The invention relates to a method for controlling an emergency device comprising at least one quick-closing valve for a combustion machine. The invention also relates to a valve control unit, and to a control device comprising an engine control unit and a valve control unit, and to a combustion machine, as per the preamble of claim 10 and of claim 11. The combustion machine has at least one quick-closing valve in an air path. In particular, the combustion machine is a combustion machine for use in explosive environments. The combustion machine is in particular a gas engine or a diesel engine.

This type of combustion machine is used for example on oil or gas platforms and as a fracking engine or as a combustion machine in which a reliable shut-down of the engine is necessary; this relates for example to a combustion machine which is utilized in the context of a rail vehicle drive—in all of these types of combustion machines, the use of quick-closing valves is advantageous. In the case of an engine which is operated in an explosive environment, such as for example a fracking engine, this may, in the event of damage, draw in combustible gas. This may give rise to an undesired increase in engine speed and thus cause a mechanical failure, posing a hazard to the surroundings.

It is known that, in the case of the abovementioned usage situation, an emergency device comprising at least one quick-closing valve must be provided which locks the air path in the event of an undesired increase in speed. Said quick-closing valve is typically arranged downstream of the compressor and of the EGR opening-in point, that is to say in the manifold pipe. Embodiments of such quick-closing valves are described for example in DE 43 10 901 A1.

Such quick-closing valves are, in systems known in the prior art, activated by an engine control unit ECU. It is desirable to minimize the risk of malfunctions in the case of such safety components.

It is this that is addressed by the invention, the object of which is to specify a method and devices by means of which the risk of malfunctions can be minimized.

Said object, relating to the method, is achieved by means of a method as claimed in claim 1. In particular, a method according to the invention for controlling an emergency device of a combustion machine, in particular of an engine, wherein the emergency device comprises at least one quick-closing valve, has the following the steps:
reading in a threshold value for an overspeed of the combustion machine,
detecting a second speed of the combustion machine by means of a second speed sensor,
performing a plausibility check on the second speed, wherein the plausibility check comprises:
reading in a first speed detected by means of a first speed sensor of an engine control unit (ECU);
calculating a difference between the second speed and the first speed,
comparing the difference with a stored threshold value for the difference,
if the difference is smaller than the threshold value for the difference, outputting a plausible signal,
after receipt of the plausible signal, reading in the second speed,
using the second speed for an activation process of the emergency device in a manner dependent on the overspeed.

The invention is based on the realization that, through the use of a second speed sensor and the additional plausibility check of the second speed detected by said second speed sensor by means of a comparison with a first speed detected by a first speed sensor of an engine control unit, the safety of the system can be improved, because two independent values for the speed are present and, in addition to the speed-dependent activation of the emergency device, a further monitoring function is ensured by means of the required plausibility checking. Furthermore, a high level of process reliability is realized, because manipulations are prevented by means of the two independent measurement values for the speed.

The invention furthermore comprises the realization that such improved process reliability can, through the utilization of an additional valve control unit for the emergency device, be achieved functionally separately from the engine control unit. The object relating to the device is achieved by the invention by means of a valve control unit which is designed to carry out a method according to the invention, wherein the valve control unit is connectable to a second speed sensor. The object is furthermore achieved by means of the control device comprising an engine control unit and a valve control unit of said type, which is functionally separate from the engine control unit.

For the achievement of the object with regard to the device, the concept of the invention also leads to a combustion machine having an emergency device comprising at least one quick-closing valve in an air path of the combustion machine, wherein the combustion machine has a valve control unit designed to carry out a method according to the invention, and has a second speed sensor independent of a first speed sensor. The concept of the invention furthermore leads to a combustion machine having an emergency device, in particular an emergency device comprising at least one quick-closing valve in an air path of the combustion machine, wherein the combustion machine has a control device comprising a valve control unit according to the invention and an engine control unit and also a second speed sensor independent of a first speed sensor of the engine control unit.

Advantageous refinements of the invention emerge from the subclaims and specify, in detail, advantageous possibilities for realizing the above-discussed concept in the context of the stated object and with regard to further advantages.

In particular, it is advantageous if the threshold value for the overspeed is automatically read in upon an initial commencement of operation, and said threshold value is provided by the engine control unit. This permits an automatic transfer of system-relevant parameters without the need for manual input or setting.

The activation process of the emergency device preferably comprises the following steps:
repeatedly comparing the second speed with the threshold value for the overspeed,
if the second speed is higher than or equal to the threshold value for the overspeed, activating the emergency device, in particular closing the at least one quick-closing valve, and outputting a corresponding emergency signal to the engine control unit. In this embodiment, the second speed, on which a plausibility check has been performed in advance, is used for the monitoring of the speed, that is to say for the comparison with the threshold value for the overspeed, which permits increased reliability of the speed used. By virtue of the at least one quick-closing valve being closed, it is ensured that no further laden air can be drawn into the combustion machine.

In particular, it is advantageous if the second speed sensor comprises a measuring wheel or toothed wheel with a number of teeth z, by means of which the speed is detected. In the context of a preferred refinement, in addition to the threshold value for the overspeed, a number n of quick-closing valves and a number of teeth z of a measuring wheel of the second speed sensor are read in, and the read-in values are subsequently validated, in particular during the course of an initial commencement of operation. The reading-in and validation of these values, that is to say the check as regards whether a correct activation—that is to say an activation which ensures reliable operation—of the emergency device takes place on the basis of these values, further increases the process reliability, because it is ensured in this way that the activation process is initiated in the event, and only in the event, of a departure from the corresponding boundary conditions that are defined for reliable operation.

If the validation fails, a corresponding fault signal is output to the engine control unit ECU, and a commencement of operation of the valve control unit is terminated. The validation may be performed both as a measure of an initial commencement of operation and during the course of re-commencements of operation.

In particular, it is advantageous if the validation of the read-in values comprises the execution of an overspeed test, in the case of which—preferably by corresponding signal output or by corresponding operation of the combustion machine—a speed corresponding to a stored threshold value for the overspeed is simulated or generated. Preferably, a check is subsequently performed as regards whether the activation of the emergency device has correspondingly taken place. The correct activation of the emergency device in the event of damage is thus assured. It is thus established in particular that the activation takes place only if the threshold value is reached or overshot. It is advantageously furthermore the case that no activation of the emergency device takes place during operation below the threshold value.

In one advantageous refinement of the method, in the event of a failure of the plausibility check, in particular if the difference is greater than or equal to the threshold value for the difference, an alarm signal is output to the engine control unit (ECU). This step increases the reliability of the method and of the emergency device further, because faults can be logged, and can be initiated by means of corresponding measures.

Preferably, in the event of an emergency stop signal, in particular an emergency stop signal triggered by a user or by some other monitoring device of the combustion machine, being read in, an activation of the emergency device is performed, and an outputting as an emergency signal to the engine control unit (ECU) is performed. Thus, in the event of an emergency stop, it is ensured that the at least one quick-closing valve of the emergency device closes, and operationally critical states are avoided, even if the threshold value for the overspeed has not been overshot prior to this.

In particular, a refinement is advantageous which has the additional step whereby, upon the receipt of the emergency signal and/or of the alarm signal, an alarm is output, and/or an engine stoppage, in particular an injection stoppage, is triggered, by the engine control unit. In this way, it is ensured that, after activation of the emergency device, in particular after the closing of the at least one quick-closing valve, this is firstly logged and, secondly, it is also the case that the combustion machine is stopped in order to avoid damage.

In one advantageous refinement of the valve control unit and of the control device, the valve control unit is connectable and/or connected by means of a bus, in particular a CAN bus, to the engine control unit. Furthermore, the valve control unit is preferably designed to additionally output an availability signal, that is to say to transmit information to the effect that the emergency device is available and intact, in the event of successful validation and plausibility checking.

Embodiments of the invention will now be described below on the basis of the drawing. This is not necessarily intended to illustrate the embodiments to scale; rather, where expedient for explanatory purposes, the drawing is of schematic and/or slightly distorted form. With regard to additions to the teaching that emerges directly from the drawing, reference is made to the relevant prior art. It must be taken into consideration here that numerous modifications and changes may be made with regard to the form and the detail of an embodiment without departing from the general concept of the invention. The features of the invention disclosed in the description, in the drawing and in the claims may be essential to the refinement of the invention both individually and in any desired combination. Furthermore, the scope of the invention encompasses all combinations of at least two of the features disclosed in the description, in the drawing and/or in the claims. The general concept of the invention is not restricted to the exact form or the detail of the preferred embodiments shown and described below, or restricted to a subject matter that would be restricted in relation to the subject matter claimed in the claims. Where dimension ranges are specified, it is also the intention for values lying within the stated limits to be disclosed, and to be capable of being used and claimed as desired, as limit values. For the sake of simplicity, below, the same reference designations are used for identical or similar parts or parts with identical or similar function.

Further advantages, features and details of the invention will emerge from the following description of the preferred embodiments and on the basis of the drawing; in which:

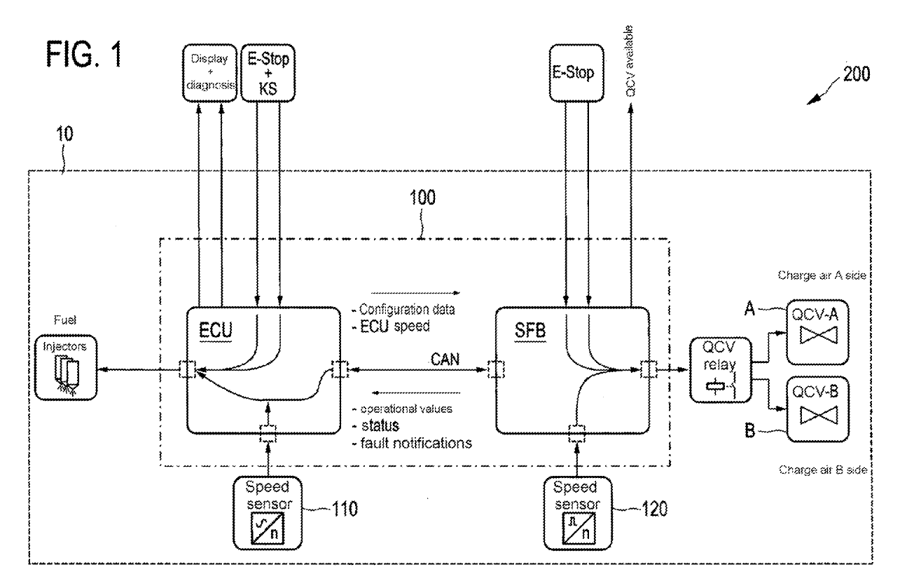

FIG. 1 is a schematic illustration of a control device having an engine control unit and having a valve control unit which is functionally separate from the engine controller;

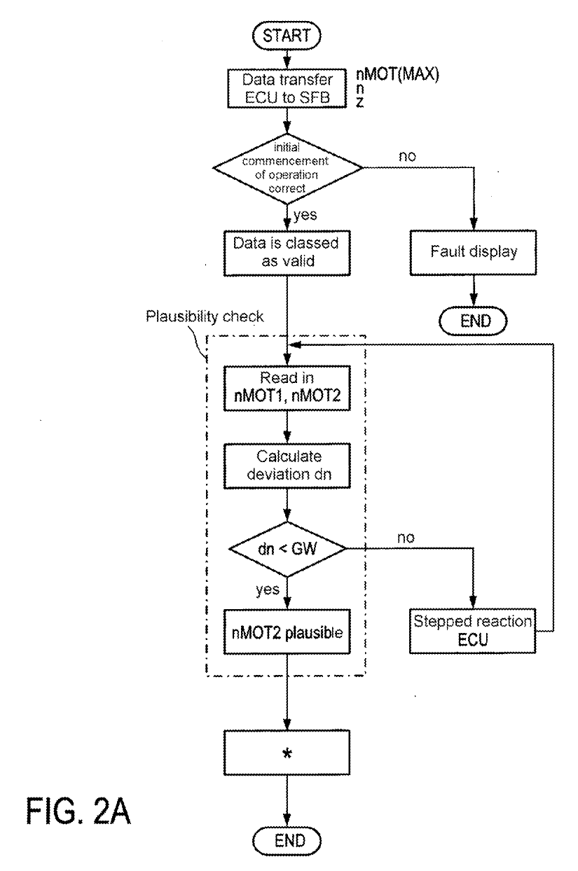

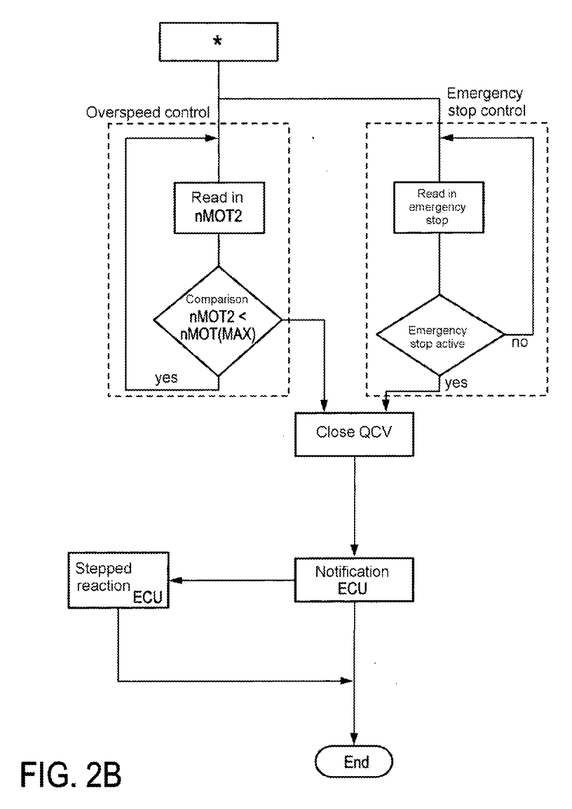

FIG. 2A shows a flow diagram of an embodiment of a method for controlling an emergency device;

FIG. 2B shows a supplementary part of the flow diagram of the method as per FIG. 2A;

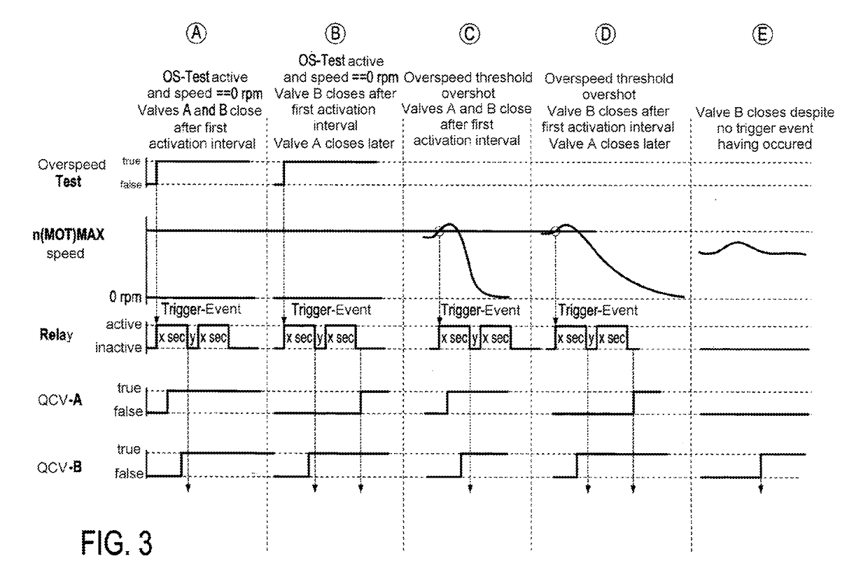

FIG. 3 is a schematic illustration of a validation step of a method for controlling an emergency device with various scenarios;

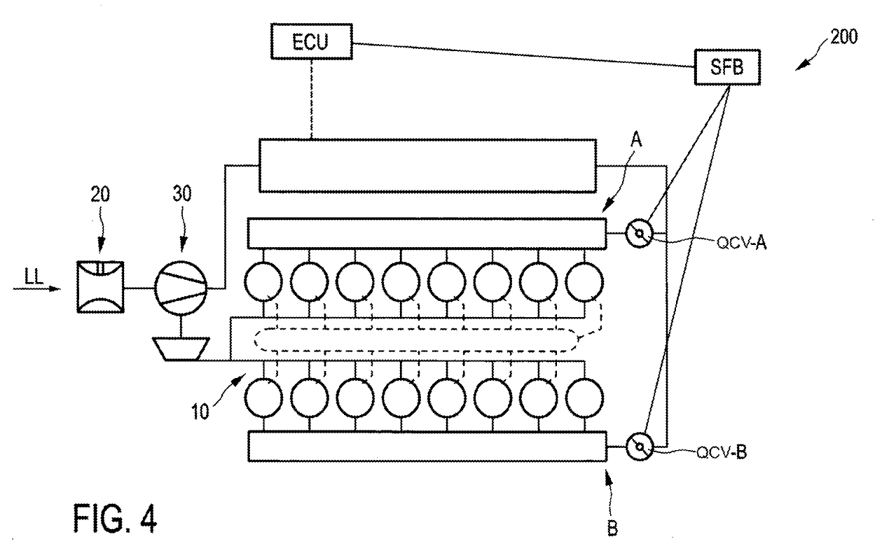

FIG. 4 is a schematic illustration of a combustion machine having an emergency device comprising two quick-closing valves and having a control device comprising an engine control unit and a valve control unit.

FIG. 1 shows, in a schematic illustration of a combustion machine 200, a control device 100 having an engine control unit ECU and having a valve control unit SFB, which is functionally separate from the engine control unit ECU, for an engine 10. The engine control unit ECU and the valve control unit SFB are in this case connected to one another by means of a bus, in this case a CAN bus, CAN. In particular upon an initial commencement of operation, items of configuration data such as a threshold value for an overspeed nMOT(MAX), a number of teeth z of a measuring wheel of the second speed sensor 120 and a number n of quick-closing valves, are transmitted from the engine control unit to the valve control unit SFB. During further operation, the engine control unit transmits to the valve control unit SFB a speed nMOT1 detected by a first speed sensor 110, said valve control unit performs a plausibility check on a second speed nMOT2 detected by a second speed sensor 120 by means of a comparison with the first speed nMOT1, and performs a comparison of the deviation, that is to say of the difference between the first and second speeds, with a threshold value GW for the difference. The valve control unit is furthermore designed such that, if the difference is smaller than the threshold value GW, it uses the second speed nMOT2 in the activation process of the emergency device. The valve control unit SFB is furthermore designed to repeatedly compare the second speed nMOT2 with the threshold value for the overspeed nMOT(MAX) during the course of the activation process, and to activate the emergency device, which in the exemplary embodiment shown has two quick-closing valves QCV-A and QCV-B, one on each charge-air side of the combustion machine, if the second speed is higher than or equal to the threshold value for the overspeed nMOT(MAX). In the present case, this is realized by means of the activation of a QCV relay, which effects the closing of the quick-closing valves QCV-A and QCV-B. Furthermore, the valve control unit is designed to output a corresponding emergency signal to the engine control unit ECU. The engine control unit ECU is designed to stop an injection of the injectors, and thus stop the engine, upon receipt of the emergency signal. The engine control unit is furthermore designed to display a corresponding alarm signal. The valve control unit SFB is designed to transmit both operating values and also status and fault notifications of the emergency device to the engine control unit during operation. Said engine control unit is itself designed such that, in response to fault notifications, it initiates the display of said faults to a user, and initiates a diagnosis.

In particular, the valve control unit SFB is designed to validate the values transmitted by the engine control unit ECU, wherein the validation of the read-in values comprises the execution of an overspeed test, in the case of which, by corresponding signal output or by corresponding operation of the combustion machine, a speed higher than the stored threshold value for the overspeed is simulated or generated, and subsequently, a check is performed as regards whether the activation of the emergency device has correspondingly taken place. Various scenarios of this overspeed test will be discussed in more detail with reference to FIG. 3.

If the validation fails, the valve control unit SFB is designed to output a corresponding fault notification to the engine control unit ECU. The valve control unit SFB is likewise designed to output a corresponding fault notification or alarm signal to the engine control unit ECU in the event of a failure of the plausibility check, in particular if the difference between second speed nMOT2 and first speed nMOT1 is greater than or equal to the threshold value for the difference. Furthermore, the valve control unit SFB is designed such that, in the event a successful validation and plausibility checking, it additionally outputs an availability signal, that is to say transmits information to the effect that the emergency device is available and intact.

Upon receipt of an emergency stop signal, the valve control unit SFB is designed to activate your the emergency device with the two quick-closing valves QCV-A and QCV-B and output an emergency signal to the engine control unit ECU. The engine control unit is designed to trigger an engine stoppage, in particular an injection stoppage of the injectors of the combustion machine, both in response to an emergency signal of the valve control unit SFB and in response to an emergency stop signal a user or of some other monitoring device.

FIG. 2A shows a flow diagram of an embodiment of a method for controlling an emergency device. In the first step, after the start of the method, data is transmitted from an engine control unit ECU to a valve control unit SFB. Thus, a threshold value for an overspeed of the combustion machine nMOT(MAX), a number n of quick-closing valves of the emergency device, and a number of teeth z of a measuring wheel are read in. In the next step, in this case during the course of an initial commencement of operation, the read-in values are validated by virtue of an overspeed test being performed, in which, by corresponding signal output or by corresponding operation of the combustion machine, a speed higher than the stored threshold value for the overspeed is simulated or generated, and a check is subsequently performed as regards whether the activation of the emergency device has correspondingly taken place.

If the validation, in this case the initial commencement of operation, is successful, a plausibility check is performed. This comprises the detection of a second speed nMOT2 of the combustion machine by means of a second speed sensor 120 and the reading-in of a first speed nMOT1 detected by means of a first speed sensor 110 of the engine control unit ECU, and a calculation of a difference dn between the second speed nMOT2 and the first speed nMOT1. In the next step, the difference dn is then compared with a stored threshold value GW for the difference; in the present exemplary embodiment, it is checked whether the difference dn is smaller than the threshold value GW, and if the difference dn is smaller than the threshold value GW for the difference, a plausible signal is output. After receipt of the plausible signal, the method is continued correspondingly with the steps described below with reference to FIG. 2B. If the difference dn is greater than or equal to the threshold value GW, a corresponding fault notification is performed, that is to say an alarm signal is output to the engine control unit ECU, which in turn triggers a stepped reaction, such as the outputting of an alarm signal to the user and/or the triggering of an engine stoppage. After the stepped reaction of the engine control unit ECU, the plausibility checking process begins again. In a variant which is not shown here, it is also possible, after the stepped reaction, for the method to be continued in accordance with FIG. 2B.

The further method is illustrated in FIG. 2B, wherein FIG. 2B shows two substantially mutually independent method sequences, specifically firstly an overspeed control and an emergency stop control. The overspeed control constitutes the method during normal operation for the control of the emergency device. Here, after the plausibility check on the second speed nMOT2, the second speed nMOT2 is read in and, during the course of the activation process of the emergency device, is repeatedly compared with the threshold value nMOT(MAX) for the overspeed. If the second speed nMOT2 is greater than or equal to the threshold value nMOT(MAX) for the overspeed, the emergency device is activated, that is to say the at least one quick-closing valve QCV is closed, and a notification in the form of a corresponding emergency signal is transmitted to the engine control unit (ECU). This in turn correspondingly triggers an engine stop, and/or outputs a corresponding alarm to a user.

In the second case, specifically the emergency stop control, an emergency stop signal is read in. In an optional further step, it is firstly checked whether an emergency stop is active, and if so, as described above, the emergency device is activated and the at least one quick-closing valve QCV is closed. If the emergency stop is not active, a “no” is read in, and the query as regards whether the emergency stop is active is performed once again. The method then continues correspondingly to that described above with reference to the overspeed control.

FIG. 3 illustrates various scenarios A, B, C, D and E, which can be tested in the course of a validation step. Here, the respective scenario is generated and, in accordance with the reaction of the quick-closing valves QCV-A and QCV-B, it is checked whether the previously read-in values, in particular the threshold value nMOT(MAX) for the overspeed, are valid, that is to say the triggering of the quick-closing valves has taken place correctly. Here, with regard to the overspeed test, “true” means that a signal is present to the effect that the threshold value nMOT(MAX) has been reached or overshot, and “false” means that no such signal is present. With regard to the quick-closing valves QCV-A and QCV-B, “true” means that these are closed, and “false” means that these are open.

In scenario A, a signal is applied which indicates that the threshold value nMOT(MAX) has been reached or overshot (the overshooting is thus simulated). As soon as the signal is read in, the relay that switches the two quick-closing valves is activated, and an activation sequence with two activation intervals of x seconds is run through, between which there is an inactive phase of y seconds. In the situation shown, both quick-closing valves QCV-A and QCV-B are triggered within the first activation interval. At the end of the activation sequences, a signal is output to the effect that the read-in values are valid. Scenario B differs from A in that, here, the first quick-closing valve QCV-A closes only after the second activation interval. In this case, it is optionally possible, after the first activation interval, for a fault notification to be output to the effect that the values are not valid. At the end of the activation sequences, it is then the case, as in situation A, that the signal is output to the effect that the read-in values are valid. The scenarios C and D correspond, as regards the behavior of the quick-closing valves, to the scenarios A and B. They differ with regard to the triggering factor. Here, in the scenarios C and D, the speed is actually increased, and an attainment of the threshold value nMOT(MAX) is detected, whereupon the relay is activated. It is also the case in scenarios C and D that the values are evaluated as being valid after the completion of the activation sequence. In situation E, the quick-closing valve QCV-B closes without the relay having been activated. In this case, a fault notification is output.

FIG. 4 shows a combustion machine 200 with an engine 10 which, in the exemplary embodiment shown, is a gas engine. The combustion machine 200 is illustrated with an air path LL via which charge air is drawn in via a gas mixer 20 and a turbocharger 30. Also arranged in the air path LL are two quick-closing valves QCV-A and QCV-B; in this case typically arranged downstream of the compressor of the turbocharger 30 and of an EGR opening-in point (not shown here), that is to say in the manifold pipe—one for each of the charge-air sides A and B. In a design variant that is not shown here, the at least one quick-closing valve may also be arranged at any other desired locations in the air path LL.

The combustion machine 200 furthermore has a valve control unit SFB as described above, and an engine control unit ECU connected to the valve control unit. The valve control unit SFB is connected to a second speed sensor (not illustrated here), and the engine control unit ECU is connected to a first speed sensor (likewise not illustrated here).

1-11. (canceled)

12. A method for controlling an emergency device of a combustion machine having an engine, wherein the emergency device comprises at least one quick-closing valve, the method comprising the steps of:
reading in a threshold value for an overspeed of the combustion machine;
detecting a second speed of the combustion machine with a second speed sensor;
performing a plausibility check on the second speed, wherein the plausibility check comprises:
reading in a first speed detected by a first speed sensor of an engine control unit;
calculating a difference between the second speed and the first speed;
comparing the difference with a stored threshold value for the difference; and
outputting a plausible signal if the difference is smaller than the threshold value for the difference;
reading in the second speed after receipt of the plausible signal; and
using the second speed for an activation process of the emergency device in a manner dependent on overspeed.

13. The method for controlling an emergency device according to claim 12, wherein the activation process of the emergency device comprises the following steps:
repeatedly comparing the second speed with the threshold value for the overspeed;
activating the emergency device and/or closing the at least one quick-closing valve if the second speed is higher than or equal to the threshold value for the overspeed; and
outputting a corresponding emergency signal to the engine control unit.

14. The method for controlling an emergency device according to claim 12, wherein, in addition to the threshold value for the overspeed, a number n of quick-closing valves and a number of teeth z of a measuring wheel of the second speed sensor are read in, and the read-in values are subsequently validated.

15. The method for controlling an emergency device according to claim 14, wherein the validation of the read-in values includes execution of an overspeed test, wherein subsequently, a check is performed regarding whether the activation of the emergency device has correspondingly taken place.

16. The method for controlling an emergency device according to claim 15, wherein, the overspeed test includes simulating or generating a speed corresponding to a stored threshold value for the overspeed.

17. The method for controlling an emergency device according to claim 15, including implementing the overspeed test by corresponding signal output or corresponding operation of the combustion machine.

18. The method for controlling an emergency device according to claim 14, further including outputting an alarm signal to the engine control unit upon failure of the plausibility check.

19. The method for controlling an emergency device according to claim 18, including outputting the alarm signal if the difference is greater than or equal to the threshold value for the difference.

20. The method for controlling an emergency device according to claim 12, including activating the emergency device and outputting an emergency signal to the engine control unit when an emergency signal is read in.

21. The method for controlling an emergency device according to claim 13, comprising the additional step of outputting an alarm and/or triggering an engine stoppage by the engine control unit upon receipt of the emergency signal.

22. A valve control unit for carrying out the method according to claim 12, wherein the valve control unit is connectable to a second speed sensor.

23. A control device, comprising: an engine control unit; and a valve control unit according to claim 22, wherein the valve control unit is functionally separate from the engine control unit.

24. A combustion machine, comprising: an emergency device having at least one quick-closing valve in an air path of the combustion machine; a first speed sensor; a valve control unit according to claim 22; and a second speed sensor independent of the first speed sensor.

25. A combustion machine, comprising: an emergency device; a control device according to claim 23; and a second speed sensor independent of a first speed sensor of the engine control unit.

26. A combustion machine according to claim 25, wherein the emergency device has at least one quick-closing valve in an air path of the combustion machine.
